(19) United States
(12) Patent Application Publication
(10) Pub. No.: US 2025/0368873 A1
(43) Pub. Date: Dec. 4, 2025

(54) LIGNIN-BASED ADHESIVE FORMULATIONS AND RELATED METHODS

(71) Applicant: University of Kansas, Lawrence, KS (US)

(72) Inventors: Bala Subramaniam, Lawrence, KS (US); Sandip Kumar Singh, Jaunpur (IN); Thomas P. Binder, Marion, IA (US); Erik Hagberg, Lawrence, KS (US)

(21) Appl. No.: 19/225,060

(22) Filed: Jun. 2, 2025

Related U.S. Application Data
(60) Provisional application No. 63/655,202, filed on Jun. 3, 2024.

(51) Int. Cl. C09J 197/00; C09J 11/04; C09J 11/06

(52) U.S. Cl. CPC C09J 197/005; C09J 11/04; C09J 11/06

(57) ABSTRACT

Adhesive compositions are provided which comprise a crosslinked lignin polymer network comprising lignin polymer chains and carbodiimide linkages, wherein crosslinks are present between the lignin polymer chains, between portions of a lignin polymer chain, or both, and wherein the carbodiimide linkages are each represented by formula —N═C═N—, wherein at least one “—” represents a covalent bond that connects the carbodiimide linkage to a lignin polymer chain. Adhesive formulations for providing the adhesive compositions are also provided as well as related methods.

### CROSS-REFERENCE TO RELATED APPLICATIONS

The present application claims priority to U.S. Provisional Patent Application No. 63/655,202 that was filed Jun. 3, 2024, the entire contents of which are incorporated herein by reference.

### REFERENCE TO GOVERNMENT RIGHTS

This invention was made with government support under 1919267 awarded by the National Science Foundation. The government has certain rights in the invention.

### BACKGROUND

Since the beginning of industrial development, non-renewable petroleum-derived chemicals have been used to synthesize a variety of everyday products. Phenol-formaldehyde (PF) is as one of the most manufactured commercial resins that is predominantly applied in wood industrial products, including bonding wood panels, production of plywood, laminated veneer lumber and oriented strand board. PF resins account for more than 54% globally of wood adhesive applications. Phenol and formaldehyde are employed for the synthesis of PF resins by either the novolac or resoles process. Both phenol and formaldehyde are derived predominantly from petroleum sources.

### SUMMARY

Provided are adhesives and adhesive formulations used to form the adhesives. The adhesives comprise a crosslinked lignin polymer network comprising lignin polymer chains and carbodiimide linkages. Crosslinks, at least some of which may comprise the carbodiimide linkages, are present between the lignin polymer chains, between portions of a lignin polymer chain, or both. The adhesive formulations comprise lignin polymer chains and an amino acid (e.g., lysine, leucine, etc.), which are subjected to conditions that result in the formation of the crosslinks between lignin polymer chains in the adhesives as well as the carbodiimide linkages. Other types of linkages may be present, e.g., ester linkages, amide linkages. As demonstrated in the Examples, below, the adhesives exhibit excellent binding strength to a number of different types of substrates. The binding strength, as well as other properties, of the adhesives may be tuned by adjusting a weight ratio of unozonized lignin polymer chains and ozonized lignin polymer chains in the adhesive formulations. By contrast to phenol and formaldehyde used to form a variety of commercial adhesives, lignin and amino acids are derived from biological sources, and comparatively speaking, are environmentally friendly and have negligible toxicity.

Adhesive compositions are provided which comprise a crosslinked lignin polymer network comprising lignin polymer chains and carbodiimide linkages, wherein crosslinks are present between the lignin polymer chains, between portions of a lignin polymer chain, or both, and wherein the carbodiimide linkages are each represented by formula —N═C═N—, wherein at least one “—” represents a covalent bond that connects the carbodiimide linkage to a lignin polymer chain. Adhesive formulations for providing the adhesive compositions are also provided as well as related methods.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIGS. 1A-1D. Physicochemical characteristics of lignins (acetosolv lignin (AL) and ozonized acetosolv lignin (OAL)) and lignin resins (LA (derived from acetosolv lignin and amino acid) and OLA (derived from ozonized acetosolv lignin and amino acid). FIG. 1A shows elemental (C, N) analyses and TGA residual mass in lignins and resins; FIG. 1B shows a GPC chromatogram of AL, OAL, LA and OLA; FIG. 1C shows FT-IR spectra of acetosolv lignins (AL and OAL) and lignin-amino acid (LA and OLA) resins; and FIG. 1D shows DSC analysis of lignin-amino acid (LA and OLA) resins.

FIGS. 2A-2F. Insights into the structure of lignin-based resins. ¹H NMR spectra of (FIG. 2A) acetosolv lignin resin (LA); (FIG. 2B) ozonized acetosolv lignin resin (OLA). ¹³C-¹H-HSQC NMR spectra of (FIG. 2C) aliphatic region of LA; (FIG. 2C) aliphatic region of OLA; (FIG. 2E) ³¹P NMR spectra of AL and LA; and (FIG. 2F) various hydroxyl groups in AL, OAL, LA and OLA determined using ³¹P NMR. Note: peak ‘#’ represents deuterated water.

FIGS. 3A-3C. Schematic depiction of glued wood specimens for Instron testing. FIG. 3A is a schematic showing dimensions of glued wood specimens, including balsa wood, medium density fiberboard and CDX grade plywood, glued with LA, OLA, various combinations of AL: OAL resins, PVAc and PU resins; FIG. 3B is a schematic showing dimensions of bonded walnut and maple vencer specimens, glued with LA, OLA, various combinations of AL: OAL resins, PVA and PU resins; FIG. 3C shows types of possible failure modes during tensile stress tests.

FIG. 4. Structural insights into specimen failure modes. Instron stress-strain curves using medium density fiberboard glued with lignin and commercial resins.

FIGS. 5A-5F. Comparison of mechanical performances of lignin-based and commercial resins. Tensile strengths and failure modes of various specimens glued with LA, OLA, AL:OAL (9:1), AL:OAL (3:1), AL:OAL (1:1), AL:OAL (1:3), and AL:OAL (9:1) resins; (FIG. 5A) Balsa wood; (FIG. 5B) Medium density fiberboard; (FIG. 5C) CDX grade plywood; (FIG. 5D) Maple vencer; (FIG. 5E) Walnut vencer, and (FIG. 5F) Tensile strength comparison of lignin-amino acid resin (AL:OAL, 1:1) with commercial resins (PVAc and PU) on various specimens. At least five replicates were done to assess the tensile strength of each sample. The average of these replicates is presented in FIGS. 5A-5F, except for maple veneer glued with LA and OLA resins, for which two replicates were performed.

FIGS. 6A-6B. A proposed schematic process for lignin ozonolysis and the ozonized lignin reaction with lysine; (FIG. 6A) ozonolysis of lignin; and (FIG. 6B) formation of lysine derived linkages and/or crosslinks.

FIG. 7 is a schematic of different adhesive articles that may be formed from the present adhesives.

FIG. 8 depicts chemical reactions between chemical functional groups of ozonized lignin polymer chains and amine groups of amino acids that occur in the present adhesive formulations. The donor acid (HA) may be provided by an acidic functional group on an amino acid, a lignin polymer chain, or a combination thereof.

### DETAILED DESCRIPTION

Adhesives are provided which comprise a crosslinked lignin polymer network comprising lignin polymer chains and carbodiimide linkages. Crosslinks, at least some of which may comprise the carbodiimide linkages, are present between the lignin polymer chains, between portions of a lignin polymer chain, or both. In the context of the detailed description and claims, crosslinks refer to molecular moieties and/or molecular fragments that are covalently bonded to distinct (i.e., separate) lignin polymer chains or to portions of a single lignin polymer chain, thereby linking these lignin polymer chains (or portions thereof) to one another within the network. Carbodiimide linkages refer to a molecular moiety represented by the formula —N═C═N—, wherein at least one “—” represents a covalent bond that connects the carbodiimide linkage to a lignin polymer chain, although there may be other atoms present therebetween. In embodiments, crosslinks in the crosslinked lignin polymer network comprise a carbodiimide linkage such that each “—” represents the covalent bond that connects the carbodiimide linkage to a lignin polymer chain (or different portions thereof), although there may be other atoms present therebetween. Other types of linkages may be present in the crosslinked lignin polymer network, e.g., ester linkages, amide linkages. In embodiments, crosslinks in the crosslinked lignin polymer network comprise a carbodiimide linkage and another type of linkage, e.g., an ester linkage, an amide linkage, or combinations thereof. As further described below, the various linkages and crosslinks in the crosslinked lignin polymer network are derived from chemical reactions occurring between lignin polymer chains and an amino acid in certain adhesive formulations in the presence of a base. The lignin polymer chains in the network may be ozonized lignin polymer chains or unozonized lignin polymers chains, but generally, a combination of such polymer chains are used.

Lignin is a phenolic heteropolymer primarily composed of crosslinked coniferyl alcohol, paracoumaryl alcohol, and sinapyl alcohol; an extended chain of such a phenolic heteropolymer is referred to herein as a lignin polymer chain. The lignin may be characterized by the natural source (i.e., biomass) from which the lignin is extracted. The biomass may be agricultural waste, an agricultural product, forestry waste, or a forestry product. The biomass may be a herbaceous plant, a plant that has no persistent wood stem above ground. Illustrative types of herbaceous biomass include corn stover and wheat straw. Corn cobs (distinct from corn stover) are another illustrative type of herbaceous biomass. Other types of lignin, including non-herbaccous lignin (e.g., woody lignin), may be used. Combinations of different types of lignin may be used.

The lignin may be further characterized by the procedure used to extract the lignin. Lignin may be extracted from biomass using several techniques, including organosolv, steam explosion, dilute acid hydrolysis, alkali extraction, and wet oxidation procedures. Organosolv procedures refer to the use of an aqueous organic solvent to extract the lignin from the natural source. For example, lignin extracted via organosolv procedures using acetic acid as the aqueous organic solvent may be referred to as “acetosolv lignin.”

The lignin in the present adhesives may be ozonized lignin. The term “ozonized lignin” (and polymer chains thereof) is used in reference to a component of an ozonized reaction mixture formed by exposing lignin (derived from any biomass source and extracted using any extraction technique, including those described herein) to ozone, including under conditions which oxidatively cleave certain groups (e.g., aromatic groups) from lignin polymer chains to provide cleaved groups and a remaining polymer backbone (i.e., ozonized lignin). Thus, the ozonized lignin may be characterized as a lignin polymer backbone from which a plurality of aromatic groups have been cleaved. However, as further described below, ozonolysis generates oxygen-containing functional groups in this lignin polymer backbone, e.g., ketones, carboxylic acids, aldehydes, etc. Thus, these oxygen-containing functional groups are present in the lignin polymer backbone. The ozonolysis conditions and techniques used may be those as described in U.S. Pat. Nos. 10,745,335 or 12,234,329, both of which are hereby incorporated by reference in their entirety. After ozonolysis, the ozonized reaction mixture comprises the ozonized lignin and the cleaved groups. These portions of the ozonized reaction mixture may be separated from one another, and the ozonized lignin (i.e., consisting of the lignin polymer backbone without the cleaved groups) may be used to provide the present adhesives. In such embodiments, the cleaved groups and the ozonized reaction mixture are not used in providing the present adhesives. In other embodiments, such separation is not necessary, and these portions may be used together (or the ozonized reaction mixture itself may be used) to provide the present adhesives.

Lignin polymer chains in the adhesive that have not been ozonized may be referred to as “unozonized lignin” or as modified by the extraction procedure used, e.g., “acetosolv lignin.”

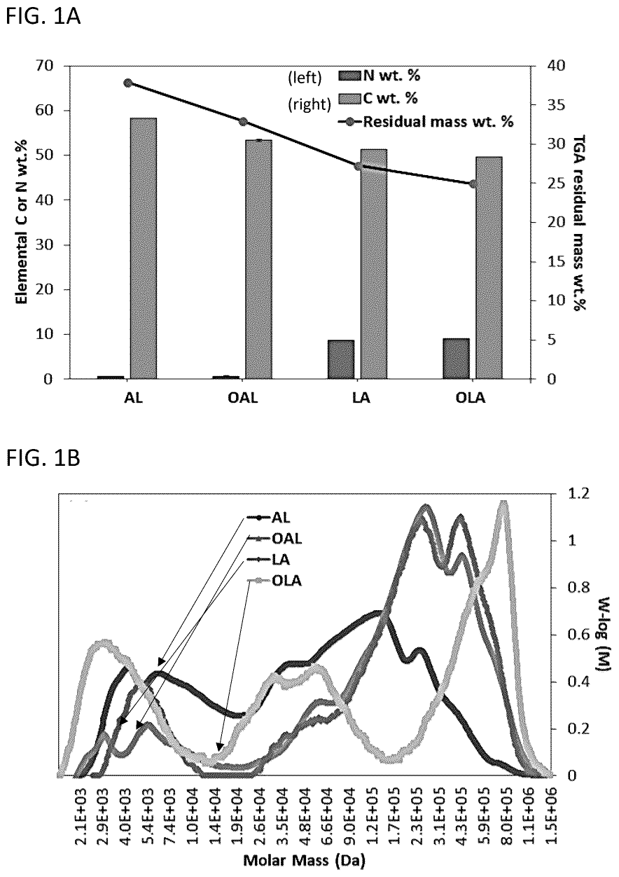

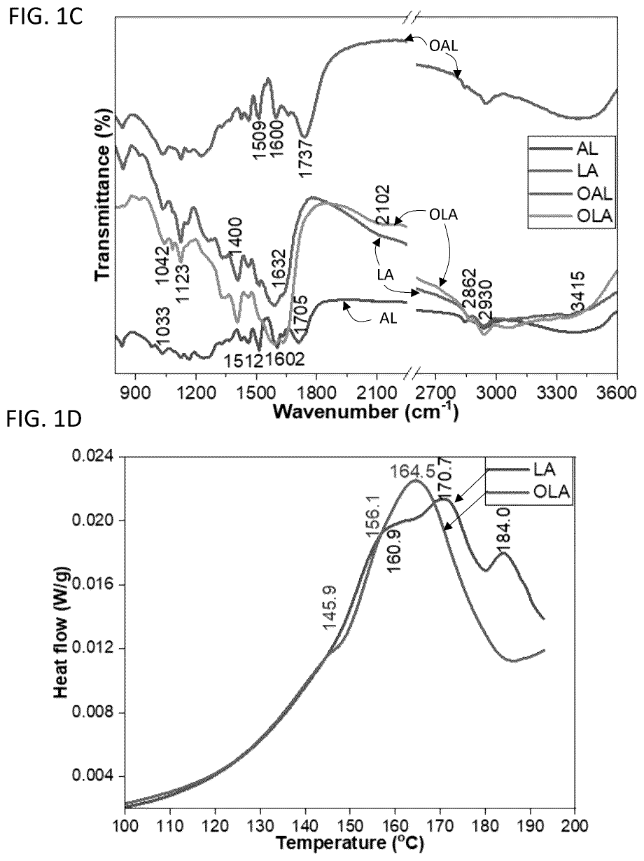

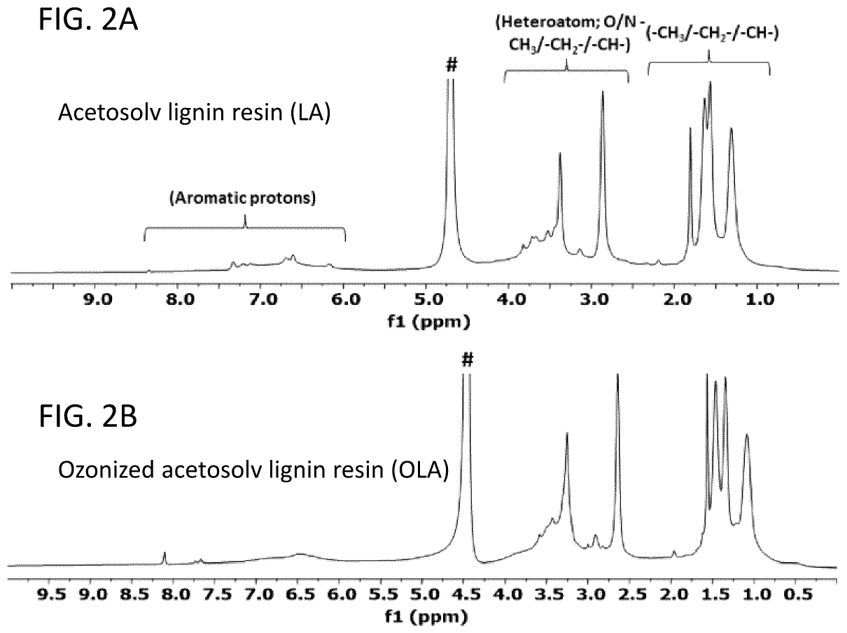

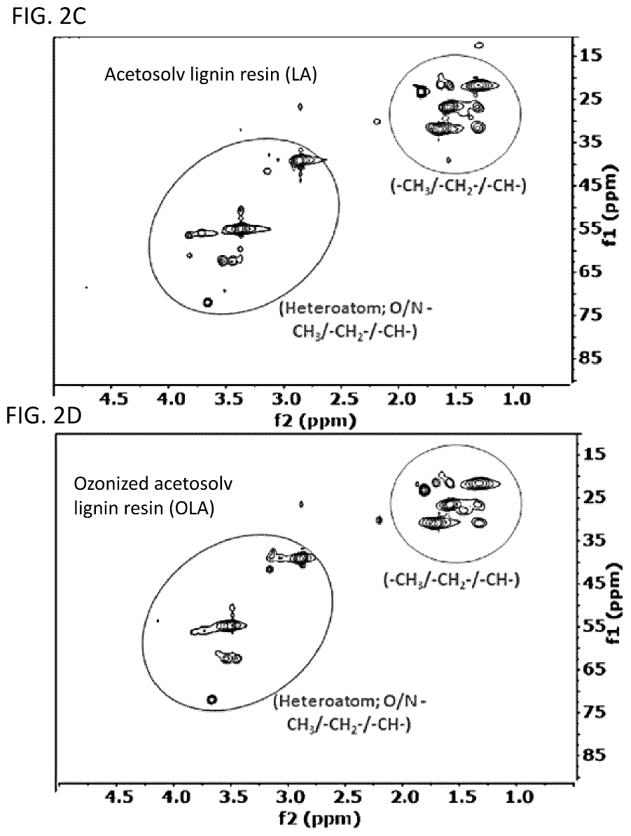

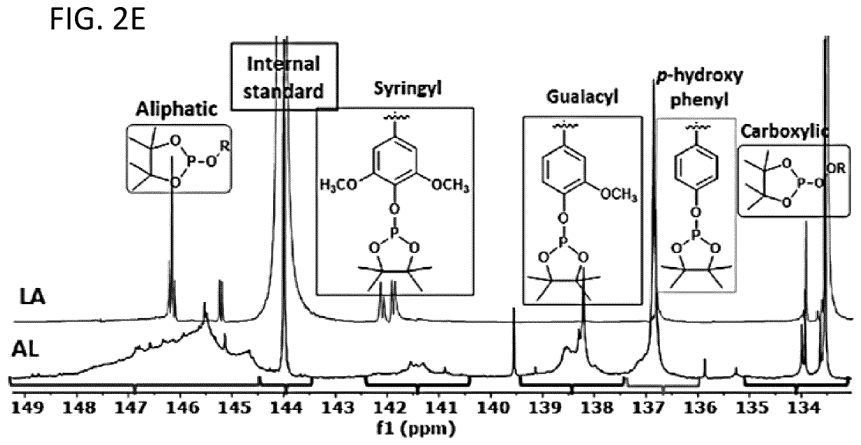

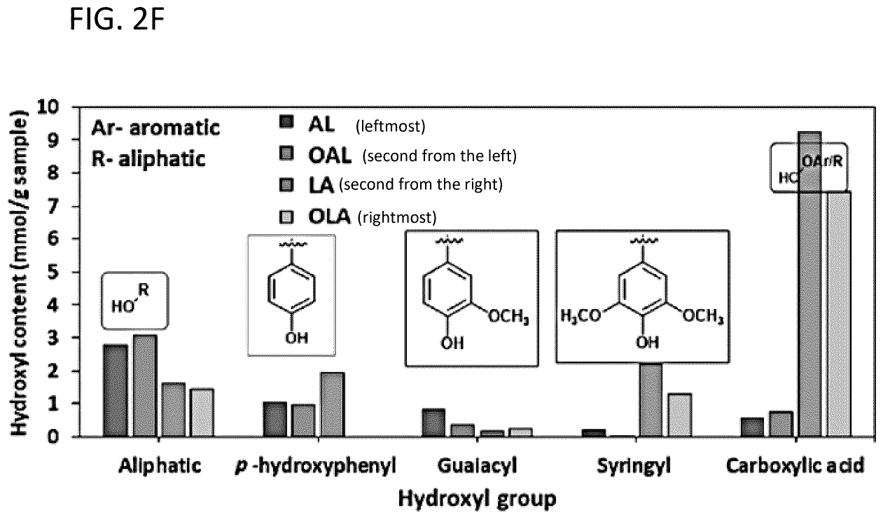

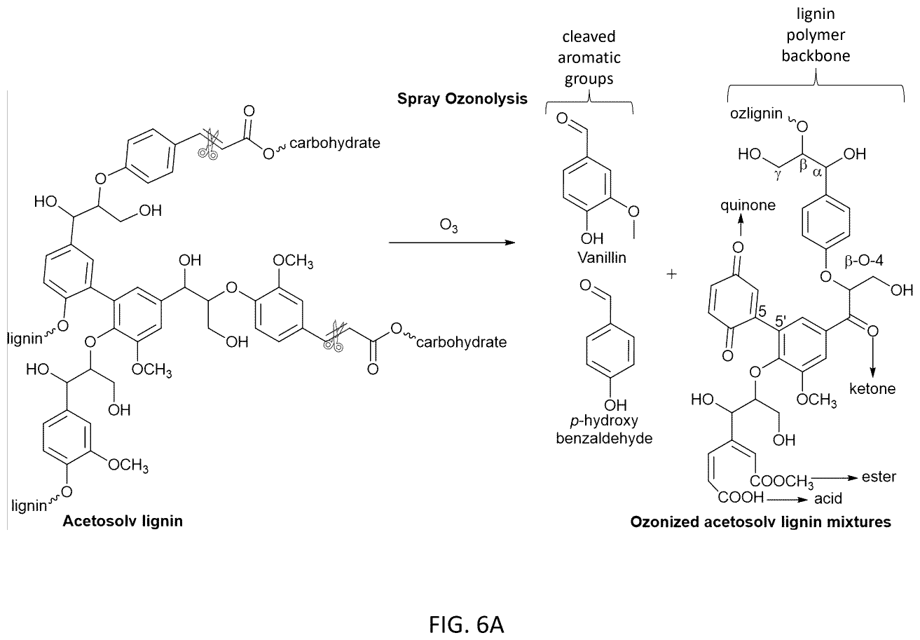

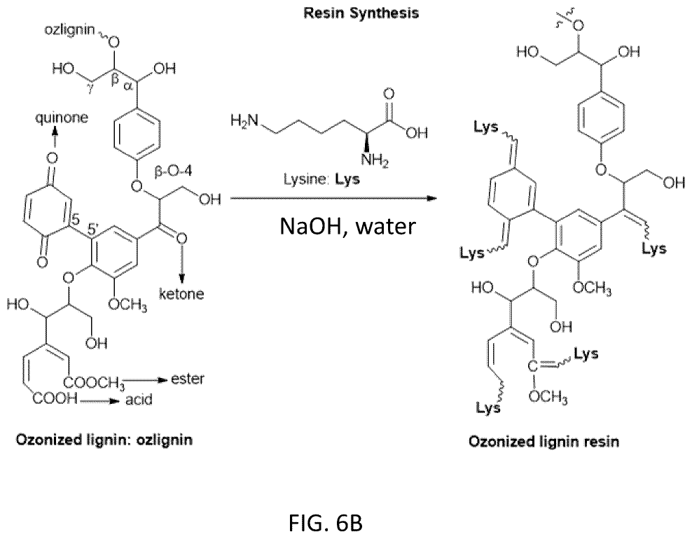

The chemical structure of a portion of a lignin polymer chain in acetosolv lignin is shown in the left image of FIG. 6A. This figure also depicts ozonolysis of the lignin polymer chain in which certain olefinic bonds are oxidatively cleaved (as depicted by the scissors), resulting in an ozonized reaction mixture comprising cleaved aromatic groups (e.g., vanillin and p-hydroxy benzaldehyde) and ozonized lignin polymer chains. This figure shows that ozonolysis results in the ozonized lignin polymer chains having oxygen functional groups such as ketones, carboxylic acids, aldehydes, esters, and quinones. Thus, ozonized lignin is distinguished from unozonized lignin by having a different chemical structure and different functional groups. Ozonized lignin and unozonized lignin also differ from one another in terms of other physicochemical and structural characteristics as described in Example 2, below, many of which translate to differences in the physicochemical and structural characteristics of adhesives including such lignins. (See also FIGS. 1A-1D and 2A-2F.) Thus, the various techniques used to measure these physicochemical and structural characteristics as described in the Examples, below, may be used to distinguish adhesives formed from ozonized lignin or unozonized lignin.

The ozonized lignin and unozonized lignin described above are also distinguished from the lignin prepolymers disclosed in U.S. Pat. No. 12,234,329. Such lignin prepolymers are the reaction product of ozonized lignin and cleaved aromatic monomers in the presence of a strong acid. However, as described above, this is not the case with either the ozonized lignin (which consists of the lignin polymer backbone without the cleaved groups) or the unozonized lignin (which has not been subjected to ozonolysis) in the present adhesives.

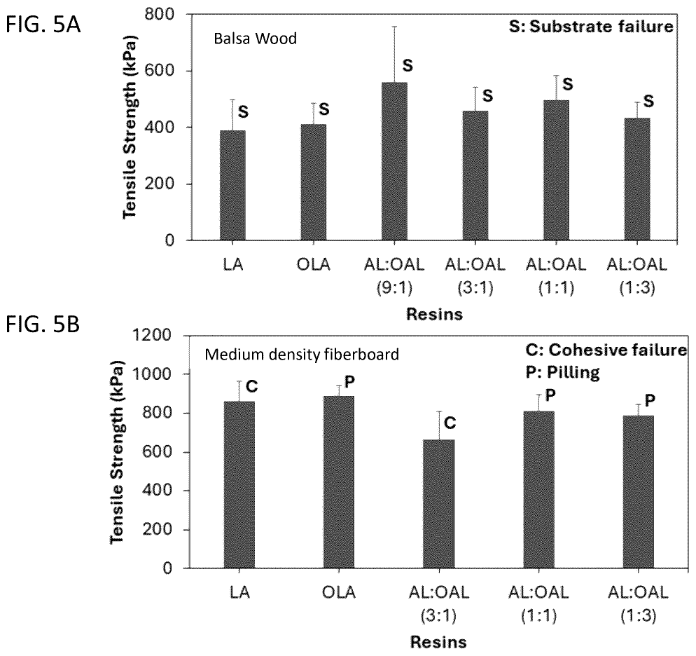

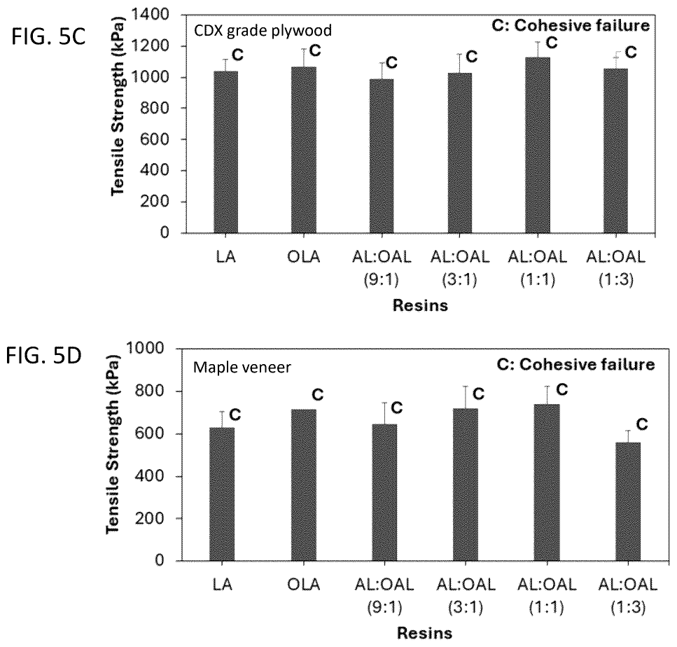

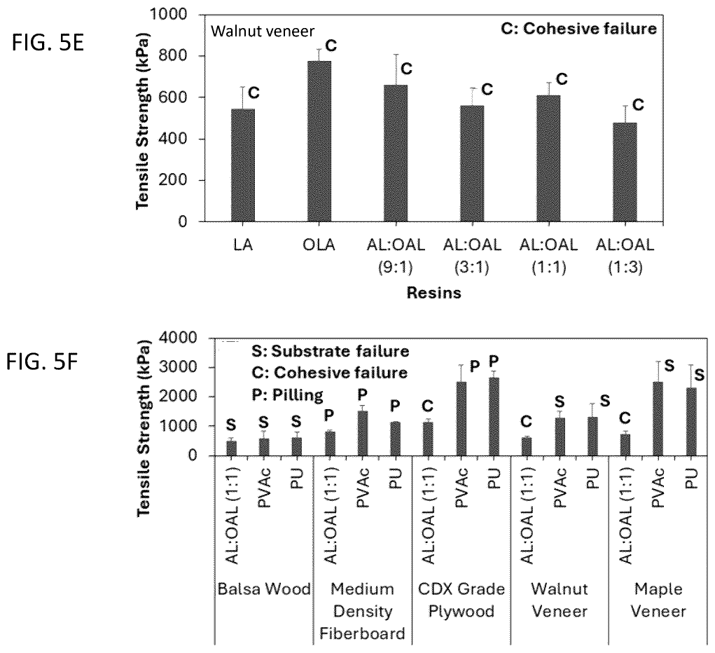

Although the present adhesives may comprise cither unozonized lignin polymer chains or ozonized lignin polymer chains, as demonstrated in Example 2, below, it has been found that a combination of unozonized lignin polymer chains and ozonized lignin polymer chains provide optimal adhesives (in terms of binding strength) for a number of applications. (See also FIGS. 5A-5F.) This is surprising since using only ozonized lignin polymer chains would have been expected to provide the best adhesives. In addition, it has been found that the relative amounts of unozonized lignin polymer chains and ozonized lignin polymer chains may be adjusted to tune the properties of the adhesive, including its binding strength, based upon the desired substrate and application for the adhesive. In embodiments, the adhesive comprises both unozonized lignin and ozonized lignin at a weight ratio (unozonized lignin: ozonized lignin) in a range of from 1:1 to 1:5. This includes a weight ratio of 1:2, 1:3, 1:4, and a range between any of the values in this paragraph. Binding strength refers to tensile strength, which may be measured as described in Example 2, below.

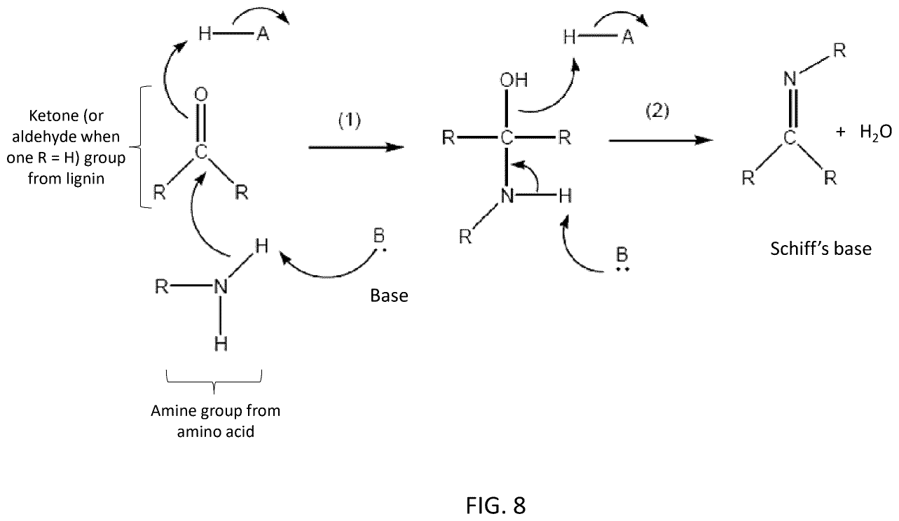

As noted above, the present adhesives are characterized by the presence of carbodiimide linkages. Confirmation of such linkages may be carried out using FTIR spectroscopy. Specifically, as shown in FIG. 1C, carbodiimide linkages give rise to a characteristic peak at 2102 cm⁻¹. Without wishing to be bound to a particular theory, the carbodiimide linkages are believed to be the result of certain chemical reactions taking place between components of the adhesive formulations used to provide the present adhesives. These chemical reactions include those occurring between ketone and/or aldehyde groups of lignin polymer chains and the amine group(s) of an amino acid in the adhesive formulations in the presence of a base. FIG. 8 illustrates a proposed reaction scheme involving the production of a Schiff base comprising a C═N moiety. The use of amino acids comprising more than one amine group can provide a carbodiimide linkage with two C═N moieties. However, as described above, and depending upon the type of amino acid used in the adhesive formulation, the present adhesives may comprise other types linkages (e.g., ester linkages) due to other chemical reactions that may occur between other functional groups of the lignin (e.g., hydroxyl groups) and/or other functional groups of the amino acid (e.g., carboxylic acid group). As also noted above, in embodiments, crosslinks that connect lignin polymer chains (or portions of a lignin polymer chain) to other another may comprise the carbodiimide linkages, the other types of linkages, or crosslinks comprising both carbodiimide linkages and the other types of linkages may be present.

Also provided are the adhesive formulations from which the present adhesives are formed. The adhesive formulations comprise lignin, an amino acid, a base, and a solvent. The lignin refers to any of the lignin polymer chains described above, including unozonized lignin polymer chains, ozonized lignin polymers chains, but generally, a combination thereof. A variety of amino acids may be used, including a single type or combinations of different types of amino acids. Amino acids comprising more than one amine group are particularly useful to provide crosslinks comprising carbodiimide linkages. Illustrative amino acids include leucine (2-Amino-4-methylpentanoic acid), lysine, and tyrosine. The amino acid may be provided by a protein, e.g., bovine serum albumin.

As noted above, the relative amounts of unozonized lignin and ozonized lignin may be adjusted in the adhesive formulations to tune the properties of the adhesive, depending upon its application. This includes using any of the unozonized lignin: ozonized lignin weight ratios provided above. However, in embodiments, the lignin in the adhesive formulation consists of unozonized lignin or consists of ozonized lignin. The relative amounts of the lignin and the amino acid may also be adjusted to tune the properties of the adhesive. In embodiments, the lignin and the amino acid are present in the adhesive formulation at a weight ratio in a range of from 100 (lignin):1 (amino acid) to 1:1. This includes weight ratios of, e.g.,: 80:1, 60:1, 40:1, 20:1, 5:1, and any range between these values.

Regarding the base in the adhesive formulations, a variety of bases and combinations thereof may be used, but the type and its amount is generally selected to deprotonate at least some acidic functional groups (e.g., carboxylic acid, hydroxyl, etc.) of the lignin. With respect to the amino acid, the basic conditions also generally result in an unprotonated amine group(s) (—NH₂) and deprotonated carboxylic acid groups (—COO⁻). Illustrative bases include alkali metal hydroxides such as NaOH. To support Schiff base formation, it is desirable for the pH of the adhesive formulation to be in a range of from 6 to 10. This includes a pH of 7, 8, 9, or any range between these values.

Regarding the solvent, a variety of solvents and combinations thereof may be used, but the type is generally selected to solubilize the lignin and the amino acid. An illustrative solvent is water.

Although other additives are not required in the adhesive formulations, they may be used as desired in any desired amount. Illustrative additives include curing agents (which may be referred to as a catalyst), fillers (e.g., carbon, metal, metal oxide, etc.), dispersants, flow agents, surfactants, etc. However, in embodiments, the adhesive formulation consists of the lignin, the amino acid (e.g., lysine or leucine), the base (e.g., NaOH), the solvent (e.g., water), and optionally, one or both of a curing agent and a flow agent. In embodiments, the lignin in such an adhesive formulation consists of unozonized lignin; consists of ozonized lignin; or consists of a combination of unozonized lignin and ozonized lignin. Prior to the present disclosure, the use of a combination of unozonized lignin and ozonized lignin has not been considered.

Certain components may be excluded from the present adhesive formulations. Such excluded components may be one or more of: any of the lignin prepolymers disclosed in U.S. Pat. No. 12,234,329; any cleaved groups resulting from the ozonolysis of lignin to provide ozonized lignin; any of diluents in Chinese Patent Publication 117821012 (e.g., dioctyl phthalate, diglycidyl ether, glycerol epoxy resin); any of the reducing sugars in International Patent Publication WO2016186459 (e.g., glucose, maltose, fructose, galactose, lactose, cellobiose, gentiobiose, lutinoose); any of the multifunctional aldehydes in WO2016186459 (e.g., glutaraldehyde, glyoxal, terephthalaldehyde). Thus, the present adhesive formulations may be characterized as being free of such excluded components.

Conversion of the present adhesive formulations to the present adhesives may be accomplished by mixing the adhesive formulations for a period of time, including under heat. The conditions (e.g., period of time and temperature) are selected to facilitate the reactions generating the carbodiimide linkages and crosslinks as described above. Conversion may be carried out using a two-stage process in which the adhesive formulations are mixed for a first period of time at room temperature, followed by mixing for a second period of time at a higher temperature. In either stage, each period of time may be, e.g., from 2 hours to 56 hours, from 4 hours to 48 hours, etc. In the second stage, the higher temperature may be, e.g., at least 50° C., at least 60° C., at least 70° C., but less than 150° C. This includes a range of between any of these values, e.g., from 50 to 100° C. As described above, formation of the carbodiimide linkages in the adhesive may be confirmed via FTIR.

As also described above, the resulting adhesive comprises a crosslinked lignin polymer network comprising lignin polymer chains and carbodiimide linkages, wherein crosslinks are present between the lignin polymer chains, between portions of a lignin polymer chains, or both. In embodiments, the lignin in such an adhesive consists of unozonized lignin; consists of ozonized lignin; or consists of a combination of unozonized lignin and ozonized lignin. If the adhesive formulation included other components, e.g., one or more curing agents, fillers, dispersants, flow agents, surfactants, etc., these components may also be present in the adhesive. Some solvent may remain in the adhesive, but enough solvent is removed such that the adhesive has a significantly higher viscosity than the adhesive formulation. The adhesive may be in the form of a semi-solid as described in the Examples, below. If the adhesive formulation is free of any of the excluded components described above, the adhesives may also be characterized as being free of such excluded components. In view of the use of the base in the adhesive formulation, some alkali metal (e.g., Na) may be present in the adhesives.

FIG. 6A schematically illustrates the conversion of an illustrative adhesive formulation containing ozonized lignin polymer chains, lysine, base (NaOH) and solvent (water) to an adhesive (ozonized lignin resin) using the method described herein. In the adhesive, at least some of the “Lys” refers to the carbodiimide linkages formed as described above. As also described above, at least some of these carbodiimide linkages may be part of crosslinks which connect the ozonized lignin polymer chain shown in the figure to another ozonized lignin polymer chain or to another portion of the ozonized lignin polymer chain.

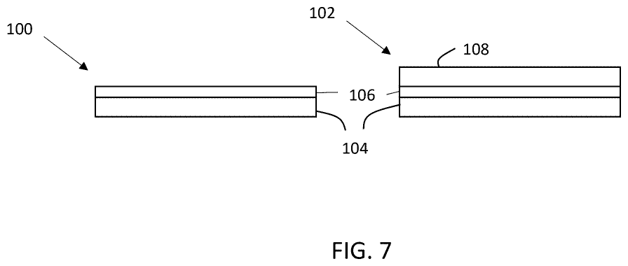

Once formed, the adhesive may be used to form an adhesive article. Such an adhesive article may be formed by applying a layer of any of the disclosed adhesives onto a surface of a substrate. Any substrate may be used, e.g., metal, glass, plastic, rubber, paper, cardboard, wood, etc. (See also the specific substrates used in the Examples, below.) The applying step may be carried out using a variety of coating techniques, e.g., painting, brushing, wiping, and the like. The layer may have any desired thickness. FIG. 7 shows two illustrative adhesive articles, 100 and 102. Both adhesive articles 100, 102 comprise a substrate 104 and a layer of an adhesive 106 formed from any of the present adhesive formulations on a surface of the substrate 104. The adhesive article 102 further comprises an additional substrate 108 which is adhered to the substrate 104 via the adhesive layer 106.

Prior to use, the adhesive (e.g., prior to forming an adhesive article) may be subjected to further processing. For example, the adhesive may be washed, e.g., with water, and dried, including under heat. Similarly, the adhesive article, prior to use in any desired application, may be subjected to further processing, e.g., drying, including under heat. In both cases, drying generally removes adsorbed water from the adhesive/adhesive article, although additional covalent crosslinks may also form.

The present disclosure encompasses any of the adhesive formulations, adhesives, adhesive articles and related methods described herein.

### EXAMPLES

### Example 1

### Introduction

In this Example, a fast, facile, and safe synthetic method was developed to provide a lignin-based adhesive from lignin and leucine in a basic medium. The synthesis was demonstrated using water as a solvent. Lignin and leucine are derived from biological sources and are environmentally friendly with negligible, if any, toxicity compared to phenol and formaldehyde. In this Example, phenol was entirely replaced with lignin, and formaldehyde was entirely replaced with leucine. High yields (˜60% based on dried lignin) of the lignin-based adhesive were achieved. No further purification, fractionation, or other such additional steps were needed for synthesizing the lignin-leucine adhesive. Any unreacted lignin and leucine may be recovered for reuse using either solvent fractionation and/or distillation. Optionally, usable sodium hydroxide can also be separated as a solid following solvent drying. Thus, the process satisfies the principles of green chemistry. Data showed that the bio-based adhesive had excellent mechanical binding strength with glass, paper, plastic, and metal. In summary, this Example demonstrates that lignin obtained from an acetosolv process can be used to form a resin with leucine in aqueous medium.

Additional information, including data indicated as not being shown, may be found in U.S. Provisional Patent Application No. 63/655,202 that was filed Jun. 3, 2024, the entire contents of which are incorporated herein by reference.

### Materials

Acetosolv and ozonized lignins were synthesized. Ozonolysis of the acetosolv lignin was carried out as described in U.S. Pat. No. 12,234,329, which is hereby incorporated by reference in its entirety. Chromium (III) acetylacetonate (97%) dimethylsulfoxide-d₆ (99.5%), and sodium hydroxide (98%) were purchased from Thermo Scientific, USA. ACS reagent grade with ASTM type I, DI water was purchased from Lab Chem, USA. L-leucine (98.5-101%) was purchased from Fisher, USA.

### Synthesis of Lignin-Based Adhesive

Either acetosolv or ozonized lignin (˜1.0 g, based on dried) was taken in a high-temperature and high-pressure glass tube (38 mL, Ace Glass, Inc.). 10 mL deionized (DI) water along with 100 mg sodium hydroxide were added to the tube contents. The contents were stirred vigorously using a stir bar at room temperature (RT, ˜20° C.) for 30 min to solubilize and activate the lignin functionalities in the basic aqueous medium. Thereafter, leucine (˜1.0 g) was added to the same mixture and stirred at RT for 4.0 h (total reaction time was 4.5 h). The resulting mixture was subjected to agitation in an oven at 60±2° C. for two days. Thereafter, the mixture was allowed to cool at RT and was centrifuged at 3,300 rpm for 10 minutes followed by washing with DI water (50 mL). The result is a semi-solid referred to as the lignin-based adhesive. This lignin-based adhesive was stored in a hood at ambient conditions for 24 h. After drying the semi-solid at 105±2° C. for 4 h (which drove off adsorbed water), the adhesive mass was measured to provide an estimate of the adhesive yield, defined as the ratio of the mass of dried adhesive to the starting mass of lignin.

### Characterization of Lignin-Based Adhesive

In the discussion below, “acetosolv-derived resin” is the adhesive formed from unozonized, acetosolv lignin and “high molecular weight (HMW)-derived resin” is the adhesive formed from the ozonized lignin.

The lignin-based adhesive was characterized using several analytic techniques, including thermogravimetric analysis (TGA), Fourier-transform infrared spectroscopy (FT-IR), ¹H, and 2D ¹H-¹³C heteronuclear single quantum coherence (HSQC) NMR. FT-IR spectra confirmed the formation of —N═C═N— groups (2130 cm⁻¹) in the lignin-based adhesive (data not shown). The TGA thermograms, obtained in flowing nitrogen at a ramp rate of 10° C./min from 50 to 800° C., showed that the lignin-based adhesive sample decomposed significantly more (˜70%) compared to the acetosolv lignin (˜63%) used for adhesive synthesis (data not shown and Table 1). The increased adhesive decomposition was attributed to the introduction of thermally labile functionalities with increased oxygen and nitrogen contents in the adhesive.

For performing NMR analysis, dried ozonized lignin (approximately 70 mg), lignin-based adhesive (approximately 50 mg), and chromium (III) acetylacetonate (approximately 2 mg) were dissolved in DMSO-d₆ (800 μL for lignin and 600 μL for adhesive). The completely dissolved mixture was processed for NMR analysis following sonication. The ¹H NMR spectrum of the lignin-based adhesive showed a more intense signal at 0.75 ppm for the methyl groups that may result from leucine in the adhesive (data not shown). Moreover, several signals in the aromatic regions that were present in the ozonized HMW lignin (data not shown), were absent in the lignin-based adhesive (data not shown). The disappearance of these signals may be due to bond formation between the carbonyl groups (which may be derived from a carboxylic acid, aldehyde, ester, or ketone) of lignin and the amine groups of leucine, leading to the formation of —N═C═N— type bonds in the lignin-based adhesive, consistent with the FT-IR spectra (data not shown).

TABLE 1
Weight of residues left after TGA analysis (N₂).

| Entry | Sample | Carbon residue (wt. %) |
|---|---|---|
| 1 | Acetosolv lignin | 37.99 ± 0.14 |
| 2 | High molecular weight | 32.79 ± 0.18 |
| | (HMW) ozonized lignin | |
| 3 | Acetosolv-derived resin | 33.44 |
| 4 | HMW-derived resin | 26.22 |

Applications of lignin-based adhesive

The adhesive properties of either acetosolv lignin-or ozonized lignin-based adhesive were assessed by applying a certain amount of the semi-solid from “Synthesis of lignin-based adhesive,” onto desired substrates in a sandwich structure, i.e., substrate-adhesive-substrate: glass (diameter ˜27.33 mm, ˜0.050 g dried adhesive used), metal

(Semicircle diameter ˜ 48.19 mm, 0.100 g dried adhesive used), plastic (diameter ˜24.17 mm, ˜0.050 g dried adhesive used), and a piece of A4 paper (1 X b X h, 14.63 X 50.75 X 0.23 mm, 0.100 g dried adhesive used). To qualitatively assess the vertical mechanical bond strength the metal, glass, and plastic bonded structures were dried in an oven ˜65+2° C. for ˜2.0 h while the A4 piece of paper was dried at ambient conditions for ˜2.0 h. In all cases, the adhesive attached firmly to the substrates, indicating the formation of strong mechanical bonding sufficient to overcome gravitational forces for ≥10 min (tested time) even for a heavy metal (data not shown).

### Example 2

### Introduction

In this Example, lignin-amino acid (LA) resins were synthesized, utilizing either acetosolv lignin, or acetosolv lignin functionalized by ozone pretreatment, or combinations thereof. The lignin was obtained from corn cobs, a field leftover, while the amino acid (lysine) was sourced from fermentation of bio-based sugars with ammonium compounds. The LA resins were thus formulated using non-toxic feedstocks and benign reagents in aqueous media. The physicochemical and structural properties of these resins were characterized by a complement of analytical techniques including nuclear magnetic resonance (NMR) spectroscopy (¹H, ³¹P, ¹³C-¹H HSQC, and ¹⁵N-¹H HMBC), Fourier transform infrared (FTIR) spectroscopy, thermogravimetric analysis (TGA), gel permeation chromatography (GPC) and elemental analysis. The ability of the synthesized resins to bond pieces of wood, metals and plastics was tested using shear test and an electromechanical tester (Instron instrument) to measure the tensile strengths of the bonded materials. Benchmarking studies show that the resins synthesized with ozone-pretreated acetosolv lignin were superior to those made without ozone pretreatment. Further, for wood-based applications, the LA resins show promising performance when compared with commercial polyurethane (PU) and polyvinyl acetate (PVAc) resins.

Additional information, including data indicated as not being shown, may be found in U.S. Provisional Patent Application No. 63/655,202 that was filed Jun. 3, 2024, the entire contents of which are incorporated herein by reference.

### Experimental

### Materials

Acetosolv lignin (AL) and ozonized acetosolv lignin (OLA) were synthesized as described in Example 1 (and see below). Chromium (III) acetylacetonate (97%), dimethylsulfoxide-d6 (99.5%), and sodium hydroxide (98%) were purchased from Thermo Scientific, USA. Deuterium hydroxide (99.9%, contained 0.05 wt. %, 3-(trimethylsilyl) propionic 2,2,3,3-d₄ acid, sodium salt) was purchased from Sigma Aldrich, USA. DI water (ACS reagent grade) was purchased from Lab Chem, USA. Lysine monohydrate (99%) and dimethyl formamide (HPLC grade, 99.5%) were purchased from Fisher Scientific, USA. Tetrabutyl-ammonium bromide (≥99.0) was purchased from Sigma Aldrich, India. All reagents were used as received. Strips of multipurpose 304 stainless steel (0.0600″ thick), multipurpose 6061 aluminum ( 1/16″ thick), balsa wood (⅛″ thick), CDX grade plywood sheet (⅜″ thick), medium density fiberboard sheet, (⅜″ thick) and polycarbonate (⅛″ thick) were purchased for McMaster-Carr, USA. Maple veneer (0.05″ thick) and walnut veneer (0.05″ thick) sheets were purchased from Amazon. Brass weights with hooks (2000 g cach) were purchased from Fisher Scientific, USA. FTIR grade potassium bromide was purchased from Sigma, USA. Polyvinyl acetate (PVAc) resin was purchased from TRAN tow Inc. Portland Colombia, OR, USA. Polyurethane (PU) resin was purchased from Akfix, Amazon, USA. Hexamethylenetetramine (HMTA, ≥99.5%) was purchased from Sigma Aldrich, USA.

### Ozone Treatment of Acetosolv Lignin

Acetosolv lignin was treated with 2.5 mol % ozone in a 6 L spray reactor. The lignin (1 wt %) was dissolved in a protic solvent (75% acetic acid by volume, 22% formic acid by volume, and 3% water by volume) and agitated at room temperature for 24 hours. The solubilized lignin was subsequently filtered using a Whatman filter 113 (CAT NO. 1113-150). Prior to lignin ozonolysis, 75 mL/min of acetic acid was passed via a MW085 Bete MicroWhirl nozzle spray nozzle for 15 minutes using an HPLC pump (PR-Class Pump P-PR 3005J-8 Chrom Tech, PA). The lignin solution was then fed through the nozzle into the reactor. The ozonized solution was collected, and the solvent was evaporated using a rotatory evaporator to be reused. Ethyl acetate (100 mL/g lignin) was mixed into the dark brown slurry and agitated overnight. The ethyl acetate-soluble (low molecular weight or LMW) and insoluble (high molecular weight or HMW) fractions of the ozonized lignins were separated and dried. The HMW fraction was referred to as ozonized acetosolv lignin (OAL) and was used to make the resin. This HMW fraction does not include any of the cleaved aromatic groups, which were separated out in the LMW fraction.

### Synthesis of Lignin-Based Resin

The lignin sample (˜1.0 g dry weight) was placed in a high-temperature, high-pressure glass tube (38 mL, Ace Glass, Inc.). DI water (10 mL) along with 100 mg sodium hydroxide were added into the tube. The contents were stirred using a magnetic stir bar at room temperature (RT˜20° C.) for 1 h to solubilize and activate the lignin functionalities such as carboxylic and hydroxyl groups. Lysine (˜1.0 g) was then added to the mixture and stirred at RT for another 4 h. The resulting mixture was placed in an oven at 60±2° C. for two days and then allowed to cool to ambient conditions, forming a lignin-amino acid (LA) resin. Lignin sample composed of unozonized acetosolv lignin and used to prepare the resin is referred to as AL (acetosolv lignin) while lignin sample composed of ozonized acetosolv lignin and used to prepare the resin is referred to as ozonized acetosolv lignin (OAL). In addition, different ratios of acetosolv lignin (AL) and ozonized acetosolv lignin (OAL) (9:1, 3:1, 1:1 and 1:3 wt/wt, respectively) were also used to prepare the resins. These resins were termed as AL:OAL (9:1), AL:OAL (3:1), AL:OAL (1:1) and AL:OAL (1:3), respectively. The resins were stored in an open tube in a fume hood at ambient conditions for 24 h. Thereafter, the mixture was stored in a 20 mL glass vial for further characterization. The synthesized resins using only acetosolv lignin (LA), only ozone-pretreated lignin (OLA) and combinations thereof were concentrated (to approximately 50% solid) on a hot plate (˜100° C., 30 min) prior to applying over the wood specimens for the Instron test.

Reactions of Lignin Model Compounds with Lysine

Lignin model compounds, including 4-hydroxy-3-methoxybenzyl alcohol, 4-hydroxy-3-methoxy acetophenone and guaiacol glyceryl ether, cumulatively representing the presence of a carbonyl group, a vacant C5 position of methoxy, and different types of hydroxyl groups [primary) (1°, secondary) (2° and phenolic (Ph-OH)] were used to gain more insights into lignin and lysine bond formation by cross-linking. The reaction between these lignin model compounds and lysine and associated work up procedures were performed following a similar procedure as explained in the preceding section.

### Physicochemical Characterization

Elemental analysis. Elemental analyses of acetosolv lignin (AL), ozonized acetosolv lignin (OAL), lignin-amino acid resin (LA) and ozonized lignin-amino acid (OLA) resin were performed by the dry combustion method. Approximately 150 mg of each sample was used for analysis. A LECO CN828 carbon/nitrogen combustion analyzer was used to determine the amounts (inorganic and organic) of C and N on a weight percent basis. Prior to elemental analysis, the resin samples were dried in a vacuum oven at 120° C. for 8 h.

Thermal analysis. Thermogravimetric analysis (TGA) of lignin and resin samples were performed using a TA SDT 600 instrument. TGA analysis of the two lignin and two resin samples (˜15 mg cach) was done in flowing nitrogen (100 std cm³/min) with a heating rate of 10° C./min from 50° C. to 800° C.

To evaluate resin curing temperatures, Differential Scanning calorimetry (DSC) analysis was done of resin samples containing hexamethylenetetramine (HMTA) using a TA SDT 600 Instrument. The HMTA was used as a curing agent in the dry resin sample at a concentration of 10 wt. %. The ground sample was oven-dried at 70+2° C. for 24 h before measurement. The sample was heated at a rate of 10° C./min from 20 to 200° C. using nitrogen and a flow rate of 50 std cm^{3/min.}

Structural insights using Fourier Transform Infrared Spectroscopy (FTIR). A Bruker Tensor 27 FTIR Spectrometer was used to determine the functional groups in the lignin (AL, and OAL) and resin (LA and OLA) samples. Approximately 1 mg of the sample was mixed with ˜99 mg IR-grade potassium bromide. The spectra were recorded from 800 to 4000 cm⁻¹ using 64 scans.

Gel Permeation Chromatography (GPC). An Agilent 1260 Infiniti GPC system was used to determine the relative molar mass distributions of the lignin and resin samples. Two columns in series, a 300 mm Polargel-M followed by a 300 mm Polargel-L, were used for molar mass analysis at 40° C. Approximately 4 mg lignin was dissolved in 1 mL dimethyl formamide (DMF, HPLC grade) while DI water (1 mL) was used to dissolve the lignin-amino acid resin (˜4 mg). DMF with 0.1 wt % tetrabutylammonium bromide (TBAB) was used as the mobile phase flowing at 1 mL/min. The column oven and RI detector temperatures were maintained at 35° C. Poly (methyl methacrylate) standards with molar masses ranging from 680 to 327,000 Da were used as calibration standards.

Structural insights using IH, ¹³C, ¹³C-¹H 2D-HSQC, ¹⁵N-¹H 2D-HMBC, and ¹⁵N-¹H HSQC correlation NMR. The ¹H, ¹³C, and ¹³C-¹H 2D-Heteronuclear Single Quantum Correlation (HSQC) and ¹⁵N-¹H 2D Heteronuclear Multiple Bond Correlation (HMBC) spectra of lysine, lignin, and resin samples were recorded using a Bruker 500 MHZ instrument. Different amounts of each sample (data not shown) with approximately 2 mg chromium (III) acetylacetonate were taken in a 2 mL transparent HPLC glass vial. The lignins were dissolved in DMSO-d₆, while D₂O was used to dissolve the lignin-amino acid resins. The mixture was sonicated under ambient conditions for approximately 15 min to facilitate complete solubilization. The homogeneous mixture was then transferred into an NMR tube and processed for analysis.

The HMBC spectra were recorded at 500.19 MHz and 50.36 MHz for ¹H and ¹⁵N nuclei, respectively. The applied current pulse program was hmbcgpndqf. The number of scans was 64 for the two lignin samples and 128 for the resin samples. The applied receiver gain was 2050 for each sample. The acquisition time for F2 (¹H) and F1 (¹⁵N) was 0.2925 s and 0.00414 s, respectively.

The ¹⁵N-¹H HSQC spectra of lysine, LA, and OLA were recorded at 599.74 MHZ and 60.77 MHz for ¹H and ¹⁵N nuclei, respectively. To record the spectra, the hsqcetf3gp pulse program was applied. The number of scans was 64 for the two lignin samples and 128 for the resin samples. The applied receiver gain for each sample was 2050. The acquisition time for F2 (¹H) and F1 (¹⁵N) was 0.2925 s and 0.00414 s, respectively.

Quantification of hydroxyl groups using ³¹P NMR. The types of hydroxyl groups present in the lignin and resin samples were determined by using ³¹P NMR spectroscopy with a Bruker 500 MHz instrument. In a glove box, approximately 9.6+1.15 mg sample was dissolved in anhydrous DMF (300 μL) and a mixture of deuterated chloroform and anhydrous pyridine (325 μL, 1:1.6 v/v). Cyclohexanol (22.0 mg/mL) as internal standard was dissolved in a mixture (100 μL) of deuterated chloroform and anhydrous pyridine mixture (1:1.6 v/v) and added to the tube. Chromium (III) acetylacetonate solution (5.0 mg/mL), as a relaxing agent, prepared in 50 μL of a mixture of deuterated chloroform and anhydrous pyridine (1:1.6 v/v), was also added to the tube. Finally, 2-chloro-4,4,5,5-tetramethyl-1,3,2-dioxaphospholane (100 μL), as a phosphorylating reagent, was added into the sample tube. The sample NMR tube was processed for ³¹P NMR spectroscopy studies employing provided parameters (not shown).

Qualitative shear test. The performance of the synthesized resins was qualitatively assessed by gluing pieces of aluminum, stainless steel, polycarbonate, and wood together and subjecting them to vertical shear by weights. (Adherent dimensions not shown.) With the exception of wood, which was glued with 200 mg of resin, the specimens were bonded together using ˜20 mg of resin. Following drying of the glued samples by drying at 60±2° C. for 2 h, the vertical shear test was done at ambient conditions.

In another test, paper was glued to wood, stainless steel, aluminum, and polycarbonate specimens with the lignin resins. (Paper and specimen dimensions not shown.) Approximately 50 mg of resin was used at each end of the paper. The glued specimens were dried at 60±2° C. for 2 hours, followed by a vertical shear test performed at ambient conditions.

Preparation of wood specimens for tensile test. A MTS Criterion Model 43 system (50 kN) was used to benchmark the tensile strengths of the lignin-based resins (LA and OLA) with commercially obtained resins [polyurethane (PU) and polyvinyl acetate (PVAc)] when bonding wood samples including balsa wood, CDX grade plywood, medium density fiberboard, walnut veneer, and maple vencer. Balsa wood, CDX grade plywood, and medium density fiberboard specimens were prepared for the Instron test using the ASTM D 2339-20 method with minor modifications, while maple and walnut veneer specimens were prepared using the ASTM D 7998-19 method. (Dimensions and glued area for all samples not shown.) Clips were used to hold the samples together when drying the resins in an oven at 60±2° C. for 2 h. Samples of identical size and resin loading were similarly prepared with the commercial resins (PU and PVAc) to analyze comparative tensile strengths. The directions of the long grain in the balsa wood, maple vencer, and walnut vencer specimens were aligned when they were glued with the lignin-amino acid resins and commercial resins. The Instron tests were carried out at a constant strain rate of 1 mm/min by applying a longitudinal load to stretch the bonded specimens. The resulting stress-strain curves and captured visual images of the tested specimens were used to interpret the mode of failure for each specimen.

### RESULTS AND DISCUSSION

### Physicochemical Characteristics of Resins

As expected, higher nitrogen contents (8.9 wt %) are observed in the resins (FIG. 1A). As shown in FIG. 1A, the residual mass reflected in the TGA profiles was lower in the lignin resins compared to the lignins from which they were made, which is attributed to the introduction of thermally labile moieties in the resins. Note that the residual masses in the case of ozone-pretreated lignins (OAL) and resins (OLA) were lower compared to the non-ozonized counterparts, attributed to the increase in the oxygen content caused by ozone pretreatment (other data not shown). GPC spectra (FIG. 1B) show that the ozone pretreatment of the acetosolv lignin (AL) largely preserved the molecular weight distribution at higher molar masses. The ozone-pretreated lignin (OAL) solution shows peaks at lower molar masses due to the formation of oligomers (FIG. 1B) and the selective cleavage of the lignin-carbohydrate complexes by ozone resulting in the formation of vanillin and p-hydroxybenzaldehyde (data not shown). Further, the molar mass distribution in the acetosolv lignin and the resin (LA) derived from it were almost similar. This suggests that the C-N cross-linking reaction between the lignin and amino acid, confirmed by the formation of a new carbodiimide crosslink (N=C═N bond) at 2102 cm⁻¹ in the LA and OLA resins (FIG. 1C), did not cause any significant shift in the molar mass distribution. The -C-N-cross-linking reaction also resulted in the abstraction of the carbonyl group (1705 and 1737 cm⁻¹) from the acetosolv lignin and ozonized acetosolv lignin samples. The slight shift in carbonyl peak of OAL was attributed to the formation of ester/carboxylic groups.

The resin prepared with ozone-pretreated lignin (OLA) displayed significantly higher molar masses (Mw=204.6 kDa) compared to the resin prepared without ozone pretreatment [LA, (Mw=139.8 kDa)]. It was speculated that this was due to increased lignin reactivity stemming from the formation of oxygen-containing functional groups upon ozone pretreatment. Elemental analysis of the ozone-pretreated lignin confirmed an increase in its oxygen content (data not shown). Additional evidence of increased oxygen content in the lignin upon ozone pretreatment is provided in the following section. Further, as discussed later, the resins prepared with ozone-pretreated lignin displayed higher tensile strengths.

FIG. 1D shows the DSC thermograms for LA and OLA resins. The curing peak temperatures of resins varied from ˜146 to 180° C., which is comparable to a phenol-formaldehyde resin. Interestingly, the OLA resin cured at lower temperatures than the LA resin.

### Structural Insights from ¹H, ¹H-¹³C HSQC and ³¹P NMR Results

The IH NMR of resins (LA and OLA) and lignins (AL and OAL) were obtained. The results for the resins are shown in FIGS. 2A-2B. The resin samples showed shifts in the aliphatic signals along with the appearance of multiple new peaks. These changes were attributed to the creation of cross-linking bonds in the resins due to interactions between the lignin and lysine. For example, the aldehyde proton peak present in the parent lignin at 9.75 ppm is absent in the resin. For the acetosolv lignin (AL), the disappearance of the aldehyde proton in the NMR spectra was consistent with the disappearance of the carbonyl group at 1705 cm⁻¹ in the FTIR spectrum (FIG. 1C). Cross-linking between amine and aldehyde groups is involved in the generation of Schiff bases.

The ¹H-¹³C Heteronuclear Single Quantum Correlation (2D-HSQC) spectra of the two lignin and two resin samples were also obtained. The results for the resins are shown in FIGS. 2C-2D. Barring the appearance of a few strong aliphatic signals in the two resins, the structural characteristics of the lignins and resins were comparable. The primary bond found in a majority of lignins, β-aryl ether, was absent in the acetosolv lignin. The occurrence of extra peaks in the aliphatic region of the resins suggests cross-linking of the amino acid with functional groups in the lignin. A majority of the aromatic signals in the acetosolv lignin were preserved in the resins.

To correlate the results of the ID and 2D NMR spectra, ³¹P NMR spectra of the lignins and resins were also obtained (FIGS. 2E and 2F). This specifically allowed the identification of the various hydroxyl groups (phenolic, secondary, and aliphatic hydroxy) involved in the cross-linking reaction between the amino acid and the lignins. Consistent with the removal of ˜10 wt % phenolic monomers (vanillin and p-hydroxybenzaldehyde, in particular) following ozonolysis of the acetosolv lignin, the ozone-pretreated lignin showed decreases in the canonical monolignols. However, the ozone-pretreated lignin showed measurable increases in the hydroxyl and carboxylic acid groups, suggesting hydroxylation of both aliphatic and aromatic groups in the ozone-pretreated lignin (see FIGS. 2E-2F and other data not shown). The signal for carbodiimide crosslinking at 2102 cm⁻¹ provided strong evidence for the cross-linking involving the aliphatic —OH groups in lignin and the —NH₂group in the amino acid, explaining the decrease in the aliphatic —OH groups in the resins. Both the lignin resins (LA and OLA) showed a decrease in G-OH (guaiacyl hydroxyl groups) and an increase in S—OH (syringyl hydroxyl groups). The number of carboxylic acid hydroxyl groups was found to be significantly higher in the LA and OLA resins compared to the lignins from which they are derived (FIG. 2F). This suggests that the amine functional groups, rather than the carboxylic acid groups, in the amino acid were mainly involved in the cross-linking reactions giving rise to the carbodiimide IR signal at 2102 cm⁻¹ in the resins (FIG. 1C).

To gain more insight into the cross-linking reaction and structure of the lignin-amino acid resins, ¹⁵N-¹H heteronuclear multiple bond correlation (HMBC) spectra of several model formulations synthesized with lysine and lignin model compounds (4-hydroxy-3-methoxyacetophenone, 4-hydroxy-3-methoxybenzyl alcohol and glycerol glyceryl ether) were investigated. Structural inputs corresponding to the ¹⁵N-¹H HMBC correlation signals were obtained (data not shown). The three ¹⁵N-¹H HMBC signals of lysine corresponded to α-amino groups at 33.1/3.2 ppm and to ε-amino groups at 29.5/2.8 and 30.7/1.6 ppm (data not shown). In most of the synthesized formulations, the ε-amino groups did not undergo any significant change. In contrast, changes were seen in the a-amino groups, suggesting that they are reactive and instrumental in creating the C-N cross-linking products. Furthermore, collected spectra showed signals for ¹⁵N-¹H at 93.9-95.1/1.4-1.6 ppm and 88.0/1.3-2.9 ppm, respectively, corresponding to formulations of 4-hydroxy-3-methoxybenzyl alcohol and lysine, 4-hydroxy-3-methoxyacetophenone and lysine, and glycerol glyceryl ether and lysinc. These formulations were exemplary of C5-lignin, forming C—N cross condensed products due to the involvement of ε-amino groups. The signal at 126.1/1.6 ppm in the 4-hydroxy-3-methoxyacetophenone and lysine product as well as the LA formulation may be indicative of interaction between carbonyl and amino groups (data not shown). Notably, the OLA resin synthesized with ozone-pretreated lignin showed an additional signal at 129.4/7.9 ppm that could be associated with new types of aromatic compounds (data not shown).

Comparison of ¹⁵N-¹H 2D-HSQC spectra of lysine (data not shown), LA resin, and OLA resin revealed that only the OLA resin exhibited a characteristic peak at 122.7/7. 3ppm in the amide/aromatic region, suggesting a different type of C-N/H-N linkage compared to the LA resin prepared with acetosolv lignin without ozone pretreatment.

### Qualitative Shear Test

The durability of the lignin resins was assessed by qualitative shear testing as described in the Experimental section. Various specimens including wood-wood (W-W), polycarbonate-polycarbonate (PC-PC), aluminum-aluminum (Al-Al) and stainless steel-stainless steel (SS-SS) as well as composite W-Al, W-PC, PC-SS, and PC-Al samples were investigated. All specimens formed robust bonds with the lignin-amino acid resins (LA and OLA). The bonded specimens can hold a load of 2 kgs that is more than six orders of magnitude greater than the weight of the applied resin for several (>23 so far) months without breaking (data not shown). Specimens glued with printed paper used to identify the specimens also show resilience during vertical shear test (data not shown).

### Tensile Strength

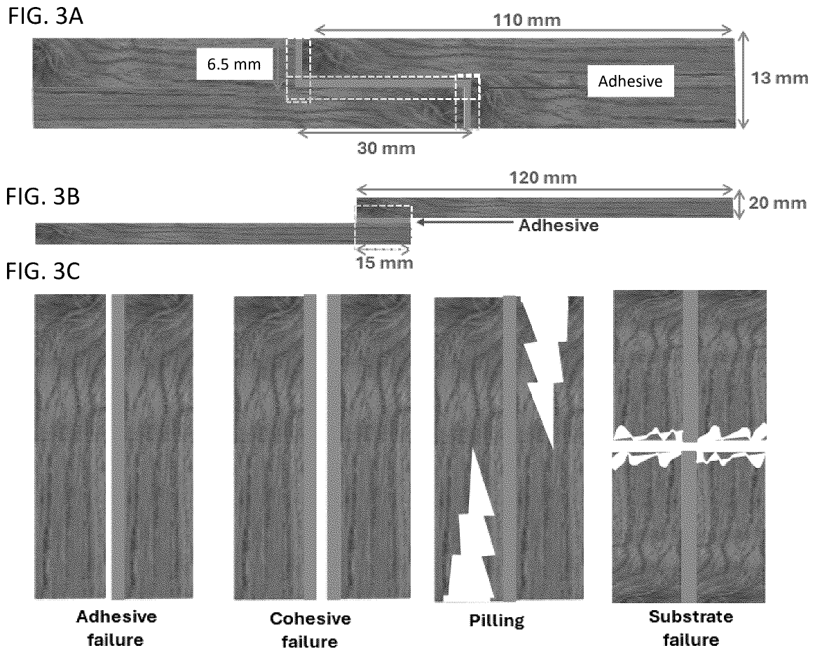

For determining the tensile strength, various lignin resins [LA, OLA, AL:OAL (9:1), AL:OAL (3:1), AL:OAL (1:1) and AL:OAL 1:3)] were used to bond pieces of wood samples including balsa, medium density fiberboard, CDX grade plywood, walnut veneer, and maple veneer samples, as described in the Experimental section. The measured tensile strengths and failure modes were compared with the bonding performance of commercial resins such as polyvinyl acetate (PVAc) and polyurethane (PU) as benchmarks. FIGS. 3A and 3B depict how different specimens glued with various lignin-based resins and commercial resins were prepared for the Instron tests.

FIG. 3C shows the different failure modes typically associated with bonded specimens. “Adhesive failure” occurs when the resin peels off cleanly from the bonded surface. “Substrate failure” occurs when the substrate breaks apart without either adhesive or cohesive failure occurring, indicating excellent resin adhesion to the substrate surface. Substrate “pilling” is associated with the stretching and peeling of substrate layers in the direction of the applied load with surface adhesion to the resins still intact. “Cohesive failure” occurs when the resin is still bonded to the two surfaces but is sheared off in the middle due to the applied tensile stress. The relative performances of the bonding abilities of the various resins in the range of applied tensile stresses were assessed based on the stress-strain curves of the various resin-bonded samples (data not shown) and visual images of the failure modes.

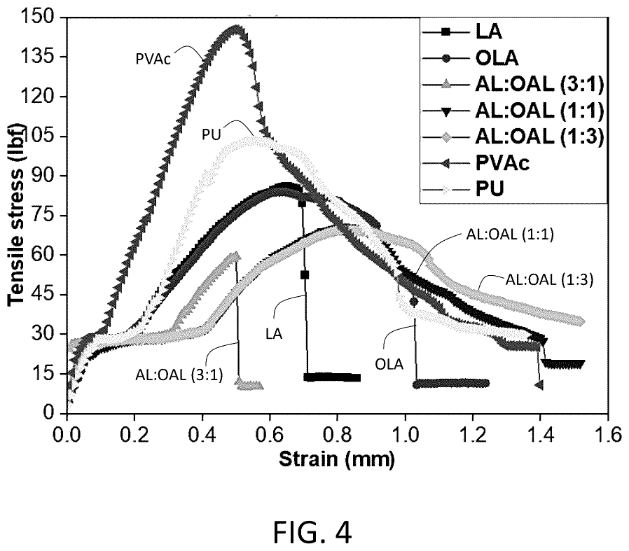

FIG. 4 shows the stress-strain curves obtained from the Instron test of medium density fiberboard specimens glued with lignin-amino acid and commercial resins. The medium density fiberboard specimens glued with LA and AL:OAL (3:1) resins showed increasing strain with applied stress followed by a sharp drop in the stress beyond a certain strain level. The sharp drop is indicative of cohesive failure as inferred from the visual images of these specimens at the failure stress (data not shown). It must be noted that the occurrences of horizontal segments in the stress-strain curves, depicting strain at constant stress, are artifacts caused by clamp slippage. Such artifacts do not, however, affect the accuracy of the stress value at failure. The tensile stress value at failure was calculated by normalizing the corresponding stress value with the glued surface area that is subjected to shear. The stress values at failure were then used for comparing the performances of the various adhesives. Note that medium density fiberboard specimens glued with OLA, AL:OAL (1:1), AL:OAL (1:3), commercial PVAc resin and commercial PU resin displayed a more gradual decline following a stress maximum (FIG. 4). This trend is characteristic of the pilling mode of failure of these specimens as also evident in their visual images post failure (data not shown).

Medium density fiberboard glued with OLA displayed the pilling mode of substrate failure (data not shown). In this failure mode, the resins formed strong bonds with the adherents, showing better tolerance to the applied stress compared to the adherent (sec also FIG. 5B). Clearly, using >50% ozone-pretreated lignin in synthesizing the composite resins imparted better surface adhesion properties to these resins. In contrast, medium density fiberboards glued with AL:OAL composite resins prepared with <50% OAL content [LA, AL:OAL (3:1)] underwent cohesive failure (data not shown). This is a clear indication that decreasing the OAL content in the composite resins weakened their bond strengths. The change in the failure mechanism with increased content of ozonized lignin in the resin suggests an opportunity for optimization aimed at maximizing the tensile strength of these resins by tuning the ozonized lignin content. The increased molecular mass (FIG. 1B), increased oxygen content of ozonized lignin (data not shown), and the evidence of C—N bond formation (FIG. 1C and other data not shown) correlated with the increased tensile strength of the resins. The resins made using OAL displayed a variety of functional groups (such as hydroxyl, acid, ester, quinone, and ketone), indicating the presence of diverse cross-linked networks, which may facilitate their stronger binding to specimens.

In a range of applied tensile stresses from 390-560 kPa, the balsa wood specimens glued with LA, OLA, and combination (AL:OAL) resins experienced substrate failure as evidenced by their tensile stress-strain curves and visual images of Instron-analyzed samples (data not shown). However, the resins were able to sustain adhesions with the surfaces (FIG. 5A and other data not shown).

With CDX grade plywood (FIG. 5C), maple vencer (FIG. 5D), and walnut veneer (FIG. 5E) samples, cohesive failure was observed with all lignin-based adhesives but under different ranges of applied tensile stresses (other data not shown). Cohesive failure occurred in the case of plywood at higher applied tensile stress compared to balsa wood and fiberboard. In contrast, plywood glued with PVAc and PU resins exhibited stress-strain curves characteristic of pilling type of failure (data not shown). Several factors, including surface interaction, mechanical interlocking between wood voids and resins, intermolecular interaction, and the nature of wood multilayer composites influence the various types of failure modes. For example, the balsa wood and fiberboard specimens possessed more surface roughness, were porous, and in some cases had favorable surface polarity to facilitate stronger surface adhesion between the specimen and the resin. In such cases, the resins applied to balsa wood and fiberboard resins can better resist shear, resulting in substrate failure at higher applied stresses. Similarly, the maple veneer (FIG. 5D) and walnut vencer (FIG. 5E) specimens glued with AL and OAL resins experienced cohesive failure at slightly lower applied stress compared to plywood. These results show that the lignin resins can function without failure in a range of applied stresses (391-1127 kPa) where commercial resins are used. Maple and walnut veneers bonded with lignin resins also demonstrated cohesive failure (data not shown). In contrast, substrate failure occurred in the case of veneers glued with PVAc and PU resins (data not shown).

For assessing the practical feasibility of the lignin-amino acid resins, the performances of AL:OAL (1:1) resin (containing 50% ozone-pretreated lignin) were compared with commercial resins (PVAc and PU) in bonding various specimens (FIG. 5F). The AL:OAL (1:1) resin showed more or less similar performance as the commercial resins in bonding either balsa wood or fiberboard. The applied stresses at which substrate failure (with balsa wood, FIG. 5D) or pilling (with fiberboard, FIG. 5E) occurred were similar, indicating that the lignin-amino acid resins can be potential substitutes in industrial balsa wood and fiberboard applications.

In the case of plywood and veneer specimens (FIGS. 5C, 5D and 5E), the cohesive failure of the commercial resins occurred at applied stress values that were more than twofold greater than the corresponding failure values for the AL:OAL (1:1) resin. The plywood, maple, and walnut samples absorbed less resin as they were less porous than balsa wood and fiberboard samples. Hence, the application of similar amounts of the resin will result in a thicker interlayer in the case of the plywood, maple, and walnut samples. To understand the effect of interlayer thickness, the amount of AL:OAL (1:1) resin applied to plywood, maple, and walnut samples was reduced by half (˜100 mg). The tensile strength at failure was reduced in these plywood, maple, and walnut samples by approximately 21%, 24%, and 35%, respectively (data not shown). These results provide guidance for further optimizing the properties of the LA resins, by adjusting the ozone-pretreated lignin content and other synthesis variables, to match or even outperform the commercial resins.

Based on the chemical and structural characterizations of the lignin and the resin, a plausible reaction scheme was suggested for oxidation of the lignin (FIG. 6A) and the formation of the resin (FIG. 6B). As shown in FIG. 6A, short contact time lignin ozonolysis in a spray reactor introduced carbonyl and hydroxyl groups in the lignin. As shown in FIG. 6B, the carbonyl groups in ozonized lignin are postulated to form linkages with the amine groups in lysine in basic media. The carboxylic hydroxyl group in the amino acid was not shown to be involved in the crosslinking reaction based on the structural characterization results described above (FIG. 2F) that reveal this group to be intact within the resin.

### Summary

Lignin-amino acid-based resins were successfully synthesized in an aqueous basic medium from renewable and abundant sources (corn cob lignin and lysine) that are non-toxic. NMR (¹H, ³¹P, ¹³C-¹H HSQC, ¹⁵N-¹H HSQC and ¹⁵N-¹H HMBC) spectroscopy, FTIR spectroscopy, TGA, clemental analysis, and GPC spectra revealed key structural features of the lignin-based resins including C-N cross linking and increased molar mass of the resins prepared with lignin pretreated with ozone. Qualitative vertical shear tests revealed that lignin-based resins can strongly bond pieces of wood, plastics, and metals. Against gravity, the bonded specimens can hold weights (2 kgs) that are roughly six orders of magnitude heavier than the weight of the applied resin. The bonds have endured for >23 months thus far without breaking. Rheological measurements revealed that the tensile strengths of balsa wood and fiberboard specimens glued with lignin-amino acid resins are comparable with those reported for similar samples bonded with commercial resins such as polyurethane (PU) and polyvinyl acetate (PVAc) resins. However, the commercial resins displayed higher tolerance for tensile stresses than the LA resins when glued with plywood and veneer specimens. Ozone-pretreated lignin provided stronger resins, offering the possibility of synthesizing optimized resins that either match or outperform the commercial resins. The lignin-amino acid resins thus show immense promise as an inexpensive and sustainable alternative for resins derived from petroleum sources.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

Unless otherwise indicated, and in recognition of the inherent nature of the techniques described herein, throughout the present disclosure, terms and phrases such as “absence,” “free,” “does not comprise,” etc. encompass, but do not require a perfect absence of the referenced entity.

Unless otherwise indicated, the term “type” as used herein refers to chemical formula such that a single type means the same chemical formula and different type means different chemical formula. Similarly, use of “more” as in “one or more” refers to use of different types of the relevant entity.

Unless otherwise indicated, throughout the present disclosure, terms such as “comprising” and the like may be replaced with terms such as “consisting” and the like.

What is claimed is:

1. An adhesive composition comprising a crosslinked lignin polymer network comprising lignin polymer chains and carbodiimide linkages, wherein crosslinks are present between the lignin polymer chains, between portions of a lignin polymer chain, or both, and wherein the carbodiimide linkages are each represented by formula —N═C═N—, wherein at least one “—” represents a covalent bond that connects the carbodiimide linkage to a lignin polymer chain.

2. The adhesive composition of claim 1, wherein at least some of the crosslinks comprise the carbodiimide linkages.

3. The adhesive composition of claim 1, wherein the lignin polymer chains comprise ozonized lignin polymer chains, each ozonized lignin polymer chain consisting of a lignin polymer backbone from which aromatic groups have been cleaved.

4. The adhesive composition of claim 1, wherein the lignin polymer chains comprise ozonized lignin polymer chains and unozonized lignin polymer chains.

5. The adhesive composition of claim 4, wherein the unozonized lignin polymer chains and the ozonized lignin polymer chains are present at a weight ratio (unozonized lignin polymer chains: ozonized lignin polymer chains) of from 1:1 to 1:5.

6. The adhesive composition of claim 1, wherein the lignin polymer chains consist of ozonized lignin polymer chains, each ozonized lignin polymer chain consisting of a lignin polymer backbone from which aromatic groups have been cleaved; unozonized lignin polymer chains; or a combination of ozonized lignin polymer chains and unozonized lignin polymer chains.

7. An adhesive article comprising a substrate having a surface and a layer of the adhesive of claim 1 on the surface.

8. An adhesive formulation comprising lignin polymer chains, an amino acid, a base, and a solvent.

9. The adhesive formulation of claim 8, wherein the lignin polymer chains comprise ozonized lignin polymer chains, each ozonized lignin polymer chain consisting of a lignin polymer backbone from which aromatic groups have been cleaved.

10. The adhesive formulation of claim 8, wherein the lignin polymer chains comprise ozonized lignin polymer chains and unozonized lignin polymer chains.

11. The adhesive formulation of claim 10, wherein the unozonized lignin polymer chains and the ozonized lignin polymer chains are present at a weight ratio (unozonized lignin polymer chains: ozonized lignin polymer chains) of from 1:1 to 1:5.

12. The adhesive formulation of claim 8, wherein the lignin polymer chains consist of ozonized lignin polymer chains, each ozonized lignin polymer chain consisting of a lignin polymer backbone from which aromatic groups have been cleaved; unozonized lignin polymer chains; or a combination of ozonized lignin polymer chains and unozonized lignin polymer chains.

13. The adhesive formulation of claim 8, wherein the amino acid is leucine, lysine, tyrosine, or a combination thereof.

14. The adhesive formulation of claim 8, wherein the base is an alkali metal hydroxide and the adhesive formulation has a pH of at least 6.

15. The adhesive formulation of claim 8, wherein the solvent is water.

16. The adhesive formulation of claim 8, wherein the adhesive formulation is free of a lignin prepolymer that is a reaction product of ozonized lignin polymer chains and aromatic groups cleaved from a lignin polymer chain; free of cleaved aromatic groups resulting from ozonolysis of lignin; free of dioctyl phthalate, diglycidyl ether, and glycerol epoxy resin; free of a reducing sugar; and free of a multifunctional aldehyde.

17. The adhesive formulation of claim 8, consisting of the lignin polymer chains, the amino acid, the base, the solvent, and optionally, one or both of a curing agent and a flow agent.

18. The adhesive formulation of claim 17, wherein the lignin polymer chains consist of ozonized lignin polymer chains, each ozonized lignin polymer chain consisting of a lignin polymer backbone from which aromatic groups have been cleaved; unozonized lignin polymer chains; or a combination of ozonized lignin polymer chains and unozonized lignin polymer chains.

19. A method of using the adhesive formulation of claim 8 to provide an adhesive, the method comprising exposing the adhesive formulation to conditions to induce chemical reactions between the lignin polymer chains and the amino acid to form the carbodiimide linkages and the crosslinks between the lignin polymer chains, between portions of a lignin polymer chain, or both, wherein the carbodiimide crosslinks are each represented by formula —N═C═N—, wherein at least one “—” represents a covalent bond that connects the carbodiimide linkage to a lignin polymer chain.

20. The method of claim 19, wherein the conditions comprise mixing for a first period of time at room temperature followed by mixing for a second period of time at an elevated temperature.
